(19) United States
(12) Patent Application Publication
(10) Pub. No.: US 2021/0173785 A1
(43) Pub. Date: Jun. 10, 2021

(54) STORAGE DEVICE AND METHOD OF OPERATING THE SAME

(71) Applicant: SK hynix Inc., Gyeonggi-do (KR)

(72) Inventors: Yong JIN, Seoul (KR); Ki Sun KIM, Seoul (KR)

(21) Appl. No.: 16/886,242

(22) Filed: May 28, 2020

(30) Foreign Application Priority Data
Dec. 4, 2019 (KR) 10-2019-0160068

(51) Int. Cl. G06F 12/0873; G06F 12/0882; G06F 12/02; G06F 13/16; G06F 9/54

(52) U.S. Cl. CPC G06F 12/0873; G06F 12/0882; G06F 2212/7201; G06F 13/1673; G06F 9/544; G06F 12/0246

(57) ABSTRACT

The present disclosure relates to an electronic device. A storage device having improved capacity scalability according to the present technology includes a first memory controller and a second memory controller. The first memory controller communicates with a host and controls a first memory device group. The second memory controller communicates with the first memory controller and controls a second memory device group. The first memory controller controls the first memory device group based on a first address mapping method, and controls the second memory device group through the second memory controller based on a second address mapping method different from the first address mapping method.

### CROSS-REFERENCE TO RELATED APPLICATION

The present application claims priority under 35 U.S.C. § 119(a) to Korean patent application number 10-2019-0160068, filed on Dec. 4, 2019, which is incorporated herein by reference in its entirety.

### BACKGROUND

### Field of Invention

The present disclosure relates to an electronic device, and more particularly, to a storage device and a method of operating the same.

### Description of Related Art

A storage device stores data under control of a host device such as a computer or a smartphone. A storage device may include a memory device in which data is stored and a memory controller controlling the memory device. The memory device may be a volatile memory device or a non-volatile memory device.

A volatile memory device stores data only when power is supplied and loses the stored data when the power supply is cut off. Examples of a volatile memory device include a static random access memory (SRAM), a dynamic random access memory (DRAM), and the like.

A non-volatile memory device does not lose data even when power is cut off. Examples of a non-volatile memory device include a read only memory (ROM), a programmable ROM (PROM), an electrically programmable ROM (EPROM), an electrically erasable and programmable ROM (EEPROM), a flash memory, and the like.

### SUMMARY

An embodiment of the present disclosure provides a storage device having improved capacity scalability and a method of operating the same.

A storage device according to an embodiment of the present disclosure includes a first memory controller and a second memory controller. The first memory controller communicates with a host and controls a first memory device group. The second memory controller communicates with the first memory controller and controls a second memory device group. The first memory controller controls the first memory device group based on a first address mapping method, and controls the second memory device group through the second memory controller based on a second address mapping method different from the first address mapping method.

A memory controller that controls a first memory device group and controls a second memory device group through a sub controller includes a map data manager and an operation controller. The map data manager stores a first mapping table corresponding to the first memory device group and a second mapping table corresponding to the second memory device group. The operation controller generates a command according to a request received from a host and provides the command to the first memory device group or the sub memory controller based on a logical address provided from the host. The first mapping table and the second mapping table are configured by different mapping units.

A storage device comprises one or more first memory devices each of which performs operations in units of pages, one or more second memory devices each of which performs operations in units of zones, a first controller configured to: control one of the first memory devices to perform an operation according to a first physical address indicating a page within the first memory devices by translating a first logical address to the first physical address; and generate a command with a second physical address indicating a zone within one of the second memory devices by translating a second logical address to the second physical address, and a second controller configured to control, in response to the command, the second memory device to perform an operation according to the second physical address, wherein the zone is a greater unit than the page.

According to the present technology, the storage device having improved capacity scalability and a method of operating the same are provided.

### BRIEF DESCRIPTION OF THE DRAWINGS

FIG. 1 is a diagram for describing a storage device according to an embodiment of the present disclosure.

FIG. 2 is a diagram for describing a structure of a memory device, such as that of FIG. 1.

FIG. 3 is a diagram for describing an operation of a memory controller that controls a plurality of memory devices.

FIG. 4A is a diagram for describing a configuration and an operation of the storage device according to an embodiment.

FIG. 4B is a diagram for describing the configuration and the operation of the storage device according to an embodiment.

FIG. 5 is a diagram for describing a structure of a storage device, such as that of FIG. 4A, according to an embodiment.

FIG. 6 is a diagram for describing the structure of a storage device, such as that of FIG. 4A, according to another embodiment.

FIG. 7 is a diagram for describing a mapping table according to an embodiment.

FIG. 8 is a diagram for describing a mapping table according to another embodiment.

FIG. 9 is a flowchart for describing operation of a storage device, such as that of FIG. 4A.

FIG. 10 is a flowchart for describing operation of a storage device, such as that of FIG. 4A, according to an embodiment.

FIG. 11 is a flowchart for describing operation of a storage device, such as that of FIG. 4A, according to another embodiment.

FIG. 12 is a diagram for describing another embodiment of a memory controller, such as that of FIG. 1.

FIG. 13 is a block diagram illustrating a memory card system to which the storage device is applied according to an embodiment of the present disclosure.

FIG. 14 is a block diagram illustrating a solid state drive (SSD) system to which the storage device is applied according to an embodiment of the present disclosure.

FIG. 15 is a block diagram illustrating a user system to which the storage device is applied according to an embodiment of the present disclosure.

### DETAILED DESCRIPTION

Hereinafter, embodiments of the present invention are described with reference to the accompanying drawings. Throughout the specification, reference to “an embodiment,” “another embodiment” or the like is not necessarily to only one embodiment, and different references to any such phrase are not necessarily to the same embodiment(s).

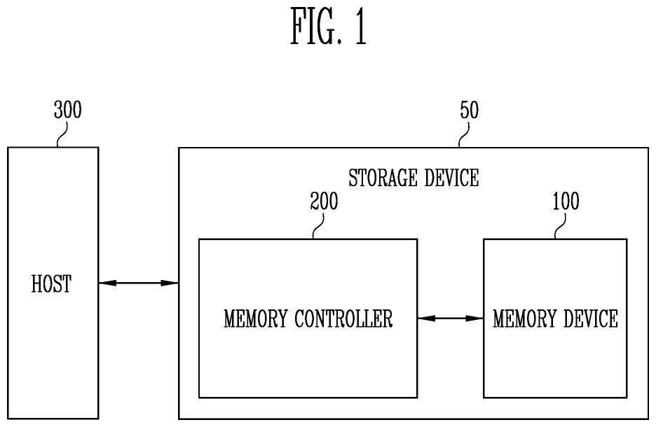

FIG. 1 is a diagram for describing a storage device according to an embodiment of the present disclosure.

Referring to FIG. 1, the storage device 50 may include one or more instances of a memory device 100 and one or more instances of a memory controller 200 that controls operation of the memory device(s). For clarity, however, only one memory device 100 and one controller 200 are shown in FIG. 1. The storage device 50 stores data under control of a host 300 such as a cellular phone, a smartphone, an MP3 player, a laptop computer, a desktop computer, a game player, a TV, a tablet PC, or an in-vehicle infotainment system.

The storage device 50 may be configured as of various types of storage devices according to a host interface that is a communication method with a host 300. For example, the storage device 50 may be configured as an SSD, a multimedia card in a form of an MMC, an eMMC, an RS-MMC and a micro-MMC, a secure digital card in a form of an SD, a mini-SD and a micro-SD, a universal serial bus (USB) storage device, a universal flash storage (UFS) device, a personal computer memory card international association (PCMCIA) card type storage device, a peripheral component interconnection (PCI) card type storage device, a PCI express (PCI-E) card type storage device, a compact flash (CF) card, a smart media card, and/or a memory stick.

The storage device 50 may be manufactured as any of various types of packages. For example, the storage device 50 may be manufactured as a package on package (POP), a system in package (SIP), a system on chip (SOC), a multi-chip package (MCP), a chip on board (COB), a wafer-level fabricated package (WFP), and/or a wafer-level stack package (WSP).

The memory device 100 may store data. The memory device 100 operates under control of the memory controller 200. The memory device 100 may include a memory cell array including a plurality of memory cells that store data.

Each of the memory cells may be configured as a single level cell (SLC) storing one data bit, a multi-level cell (MLC) storing two data bits, a triple level cell (TLC) storing three data bits, or a quad level cell (QLC) storing four data bits.

The memory cell array may include a plurality of memory blocks. Each memory block may include a plurality of memory cells. One memory block may include a plurality of pages. In an embodiment, the page may be a unit for storing data in the memory device 100 or reading data stored in the memory device 100.

The memory block may be a unit for erasing data. In an embodiment, the memory device 100 may be a double data rate synchronous dynamic random access memory (DDR SDRAM), a low power double data rate4 (LPDDR4) SDRAM, a graphics double data rate (GDDR) SDRAM, a low power DDR (LPDDR), a Rambus dynamic random access memory (RDRAM), a NAND flash memory, a vertical NAND flash memory, a NOR flash memory device, a resistive random access memory (RRAM), a phase-change memory (PRAM), a magnetoresistive random access memory (MRAM), a ferroelectric random access memory (FRAM), a spin transfer torque random access memory (STT-RAM), or the like. In the present specification, by way of example, features and aspects of the present invention are described in the context in which the memory device 100 is a NAND flash memory.

The memory device 100 is configured to receive a command and an address from the memory controller 200 and access an area selected by the address of the memory cell array. That is, the memory device 100 may perform an operation instructed by the command on the area selected by the address. For example, the memory device 100 may perform a write operation (program operation), a read operation, and an erase operation. During the program operation, the memory device 100 may program data to the area selected by the address. During the read operation, the memory device 100 may read data from the area selected by the address. During the erase operation, the memory device 100 may erase data stored in the area selected by the address.

The memory controller 200 controls overall operation of the storage device 50.

When power is applied to the storage device 50, the memory controller 200 may execute firmware FW. When the memory device 100 is a flash memory device, the memory controller 200 may operate firmware such as a flash translation layer (FTL) for controlling communication between the host and the memory device 100.

In an embodiment, the memory controller 200 may receive data and a logical block address (LBA) from the host and convert the logical block address (LBA) into a physical block address (PBA) indicating an address of memory cells in which data included in the memory device 100 is to be stored.

The memory controller 200 may control the memory device 100 to perform the program operation, the read operation, or the erase operation in response to a request from the host. During the program operation, the memory controller 200 may provide a write command, a physical block address, and data to the memory device 100. During the read operation, the memory controller 200 may provide a read command and the physical block address to the memory device 100. During the erase operation, the memory controller 200 may provide an erase command and the physical block address to the memory device 100.

In an embodiment, the memory controller 200 may generate and transmit the command, the address, and the data to the memory device 100 regardless of the request from the host. For example, the memory controller 200 may provide a command, an address, and data to the memory device 100 so as to perform background operations such as a program operation for wear leveling and a program operation for garbage collection.

In an embodiment, the memory controller 200 may control at least two memory devices 100. In this case, the memory controller 200 may control the memory devices 100 according to an interleaving method so as to improve operation performance. The interleaving method may include operating multiple memory devices 100 to perform operations in overlapping time periods.

The host may communicate with the storage device 50 using at least one of various communication methods such as a universal serial bus (USB), a serial AT attachment (SATA), a serial attached SCSI (SAS), a high speed interchip (HSIC), a small computer system interface (SCSI), a peripheral component interconnection (PCI), a PCI express (PCIe), a nonvolatile memory express (NVMe), a universal flash storage (UFS), a secure digital (SD), a multimedia card (MMC), an embedded MMC (eMMC), a dual in-line memory module (DIMM), a registered DIMM (RDIMM), and/or a load reduced DIMM (LRDIMM).

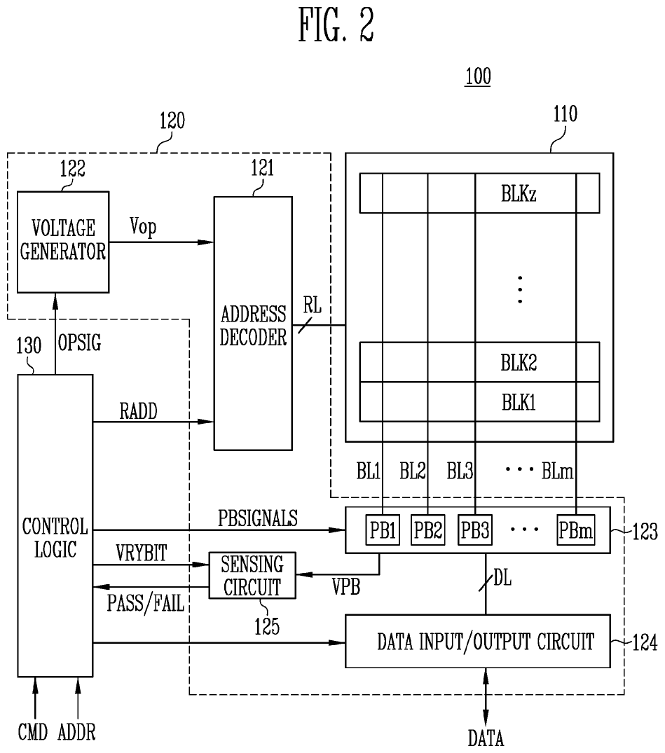

FIG. 2 is a diagram for describing a structure of the memory device of FIG. 1.

Referring to FIG. 2, a memory device 100 may include a memory cell array 110, a peripheral circuit 120, and control logic 130.

The memory cell array 110 includes a plurality of memory blocks BLK1 to BLKz that are connected to an address decoder 121 through row lines RL. The plurality of memory blocks BLK1 to BLKz are connected to a read and write circuit 123 through bit lines BL1 to BLm. Each of the plurality of memory blocks BLK1 to BLKz includes a plurality of memory cells. In an embodiment, the plurality of memory cells are non-volatile memory cells. Memory cells connected to the same word line among the plurality of memory cells are defined as one physical page. That is, the memory cell array 110 is configured of a plurality of physical pages. According to an embodiment of the present disclosure, each of the plurality of memory blocks BLK1 to BLKz included in the memory cell array 110 may include a plurality of dummy cells. At least one of the dummy cells may be connected in series between a drain select transistor and the memory cells and between a source select transistor and the memory cells.

Each of the memory cells of the memory device 100 may be configured as a single level cell (SLC) that stores one data bit, a multi-level cell (MLC) that stores two data bits, a triple level cell (TLC) that stores three data bits, or a quad level cell (QLC) that stores four data bits.

The peripheral circuit 120 may include an address decoder 121, a voltage generator 122, the read and write circuit 123, a data input/output circuit 124, and a sensing circuit 125.

The peripheral circuit 120 drives the memory cell array 110. For example, the peripheral circuit 120 may drive the memory cell array 110 to perform a program operation, a read operation, and an erase operation.

The address decoder 121 is connected to the memory cell array 110 through the row lines RL. The row lines RL may include drain select lines, word lines, source select lines, and a common source line. According to an embodiment of the present disclosure, the word lines may include normal word lines and dummy word lines. According to an embodiment of the present disclosure, the row lines RL may further include a pipe select line.

The address decoder 121 is configured to operate in response to control of the control logic 130. The address decoder 121 receives a row address RADD from the control logic 130.

The address decoder 121 is configured to decode a block address of the row address RADD. The address decoder 121 selects at least one memory block among the memory blocks BLK1 to BLKz according to the decoded block address. The address decoder 121 may select at least one word line of a selected memory block by applying voltages supplied from the voltage generator 122 to at least one word line WL according to the decoded row address RADD.

During the program operation, the address decoder 121 may apply a program voltage to a selected word line and apply a pass voltage having a level less than that of the program voltage to unselected word lines. During a program verify operation, the address decoder 121 may apply a verify voltage to the selected word line and apply a verify pass voltage having a level greater than that of the verify voltage to the unselected word lines.

During the read operation, the address decoder 121 may apply a read voltage to the selected word line and apply a read pass voltage greater than the read voltage applied to the unselected word lines.

According to an embodiment of the present disclosure, the erase operation of the memory device 100 is performed in memory block units. The address ADDR input to the memory device 100 during the erase operation includes a block address. The address decoder 121 may decode the block address and select one memory block according to the decoded block address. During the erase operation, the address decoder 121 may apply a ground voltage to the word lines input to the selected memory block.

According to an embodiment of the present disclosure, the address decoder 121 may be configured to decode a column address of the transferred address ADDR. The decoded column address may be transferred to the read and write circuit 123. As an example, the address decoder 121 may include a component such as a row decoder, a column decoder, and an address buffer.

The voltage generator 122 is configured to generate a plurality of operation voltages Vop by using an external power voltage supplied to the memory device 100. The voltage generator 122 operates in response to the control of the control logic 130.

As an example, the voltage generator 122 may generate an internal power voltage by regulating the external power voltage. The internal power voltage generated by the voltage generator 122 is used as an operation voltage of the memory device 100.

In an embodiment, the voltage generator 122 may generate the plurality of operation voltages Vop using the external power voltage or the internal power voltage. The voltage generator 122 may be configured to generate various voltages required by the memory device 100. For example, the voltage generator 122 may generate a plurality of erase voltages, a plurality of program voltages, a plurality of pass voltages, a plurality of selection read voltages, and a plurality of non-selection read voltages.

In order to generate the plurality of operation voltages Vop having various voltage levels, the voltage generator 122 may include a plurality of pumping capacitors that receive the internal voltage and selectively activate the plurality of pumping capacitors to generate the plurality of operation voltages Vop.

The plurality of generated operation voltages Vop may be supplied to the memory cell array 110 by the address decoder 121.

The read and write circuit 123 includes first to m-th page buffers PB1 to PBm that are connected to the memory cell array 110 through first to m-th bit lines BL1 to BLm, respectively. The first to m-th page buffers PB1 to PBm operate in response to the control of the control logic 130.

The first to m-th page buffers PB1 to PBm communicate data DATA with the data input/output circuit 124. At a time of program, the first to m-th page buffers PB1 to PBm receive the data DATA to be stored through the data input/output circuit 124 and data lines DL.

During the program operation, when a program voltage is applied to the selected word line, the first to m-th page buffers PB1 to PBm may transfer the data DATA to be stored, that is, the data DATA received through the data input/output circuit 124 to the selected memory cells through the bit lines BL1 to BLm. The memory cells of the selected page are programmed according to the transferred data DATA. A memory cell connected to a bit line to which a program permission voltage (for example, a ground voltage) is applied may have an increased threshold voltage. A threshold voltage of a memory cell connected to a bit line to which a program inhibition voltage (for example, a power voltage) is applied may be maintained. During the program verify operation, the first to m-th page buffers PB1 to PBm read the data DATA stored in the memory cells from the selected memory cells through the bit lines BL1 to BLm.

During the read operation, the read and write circuit 123 may read the data DATA from the memory cells of the selected page through the bit lines BL and store the read data DATA in the first to m-th page buffers PB1 to PBm.

During the erase operation, the read and write circuit 123 may float the bit lines BL. In an embodiment, the read and write circuit 123 may include a column selection circuit.

The data input/output circuit 124 is connected to the first to m-th page buffers PB1 to PBm through the data lines DL. The data input/output circuit 124 operates in response to the control of the control logic 130.

The data input/output circuit 124 may include a plurality of input/output buffers (not shown) that receive input data DATA. During the program operation, the data input/output circuit 124 receives the data DATA to be stored from an external controller (not shown). During the read operation, the data input/output circuit 124 outputs the data DATA transferred from the first to m-th page buffers PB1 to PBm included in the read and write circuit 123 to the external controller.

During the read operation or the verify operation, the sensing circuit 125 may generate a reference current in response to a signal of a permission bit VRYBIT generated by the control logic 130 and may compare a sensing voltage VPB received from the read and write circuit 123 with a reference voltage generated by the reference current to output a pass signal or a fail signal to the control logic 130.

The control logic 130 may be connected to the address decoder 121, the voltage generator 122, the read and write circuit 123, the data input/output circuit 124, and the sensing circuit 125. The control logic 130 may be configured to control all operations of the memory device 100. The control logic 130 may operate in response to a command CMD transferred from an external device.

The control logic 130 may generate various signals in response to the command CMD and the address ADDR to control the peripheral circuit 120. For example, the control logic 130 may generate an operation signal OPSIG, the row address RADD, a read and write circuit control signal PBSIGNALS, and the permission bit VRYBIT in response to the command CMD and the address ADDR. The control logic 130 may output the operation signal OPSIG to the voltage generator 122, output the row address RADD to the address decoder 121, output the read and write control signal to the read and write circuit 123, and output the permission bit VRYBIT to the sensing circuit 125. In addition, the control logic 130 may determine whether the verify operation is passed or failed in response to the pass or fail signal PASS/FAIL output by the sensing circuit 125.

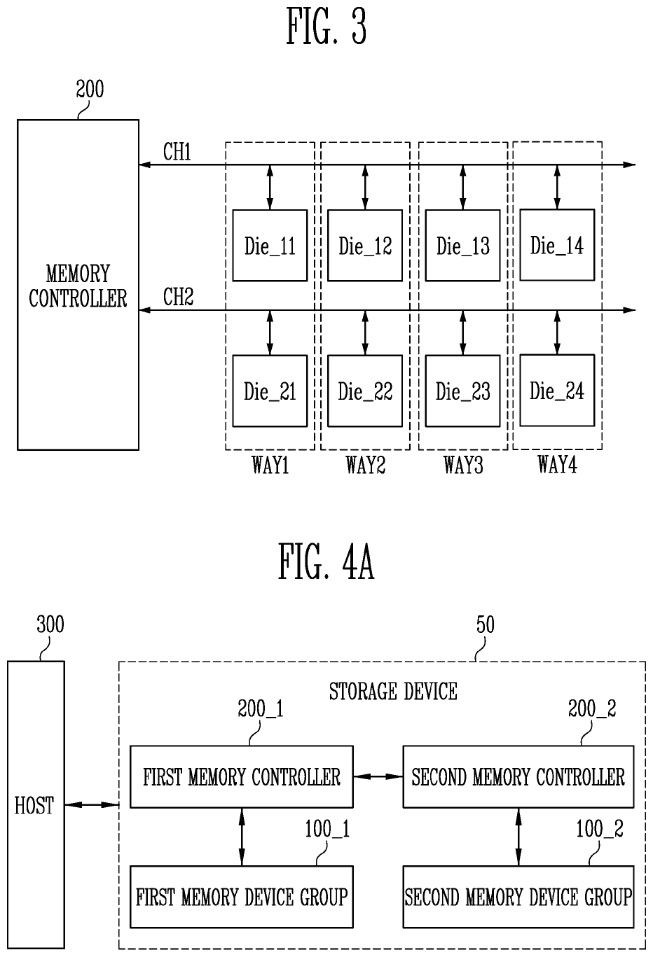

FIG. 3 is a diagram for describing an operation of a memory controller that controls a plurality of memory devices.

Referring to FIG. 3, the memory controller 200 may be connected to a plurality of memory devices (memory device_11 to memory device_24) through a first channel CH1 and a second channel CH2. The number of channels or the number of memory devices connected to each channel is not limited to the present embodiment. Each of the memory devices may be dies.

The memory device_11, the memory device_12, the memory device_13, and the memory device_14 may be commonly connected to the first channel CH1. The memory device_11, the memory device_12, the memory device_13, and the memory device_14 may communicate with the memory controller 200 through the first channel CH1.

Since the memory device_11, the memory device_12, the memory device_13, and the memory device_14 are commonly connected to the first channel CH1, only one memory device may communicate with the memory controller 200 at a time. However, each of the memory device_11, the memory device_12, the memory device_13, and the memory device_14 may simultaneously perform an internal operation.

The memory device_21, the memory device_22, the memory device_23, and the memory device_24 may be commonly connected to the second channel CH2. The memory device_21, the memory device_22, the memory device_23, and the memory device_24 may communicate with the memory controller 200 through the second channel CH2.

Since the memory device_21, the memory device_22, the memory device_23, and the memory device_24 are commonly connected to the second channel CH2, only one memory device may communicate with the memory controller 200 at a time. However, each of the memory device_21, the memory device_22, the memory device_23, and the memory device_24 may simultaneously perform an internal operation.

A storage device using a plurality of memory devices may improve performance by using data interleaving, which is data communication using an interleave method. The data interleaving may be used to perform a data read or write operation by configuring the system such that two or more ways share one channel. For the data interleaving, the memory devices may be managed in units of those connected to the same channel and way. In order to maximize parallelism of the memory devices connected to each of the channels, the memory controller 200 may allocate successive logical memory areas to be evenly distributed over the channel and the way.

For example, the memory controller 200 may transmit a command, a control signal including an address, and data to the memory device_11 through the first channel CH1. While the memory device_11 programs the transmitted data into a memory cell therein, the memory controller 200 may transmit the command, the control signal including the address, and the data to the memory device_12.

In FIG. 3, the plurality of memory devices may be configured such that there are four ways WAY1 to WAY4. The first way WAY1 may include the memory device_11 and the memory device_21. The second way WAY2 may include the memory device_12 and the memory device_22. The third way WAY3 may include the memory device_13 and the memory device_23. The fourth way WAY4 may include the memory device 14 and the memory device_24.

Each of the channels CH1 and CH2 may be a bus of signals shared and used by the memory devices connected to the corresponding channel.

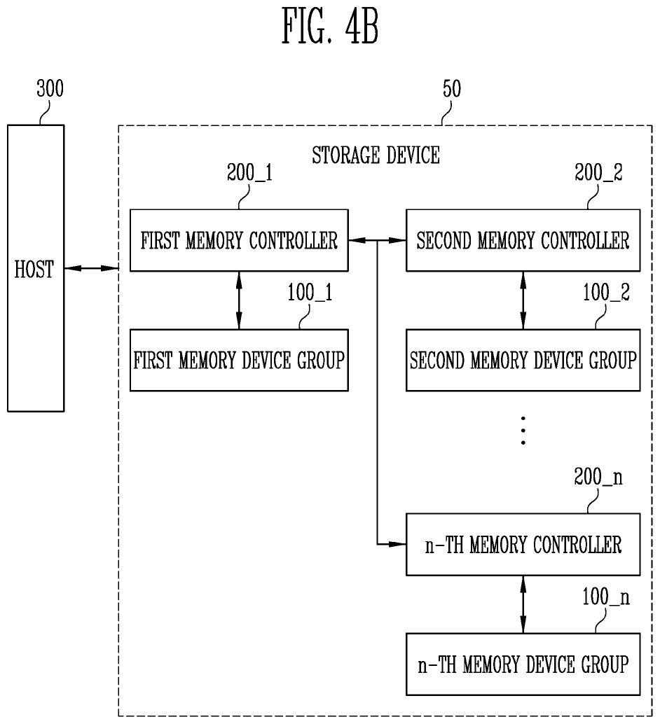

FIG. 4A is a diagram for describing a configuration and an operation of the storage device according to an embodiment.

Referring to FIG. 4A, the storage device 50 may include a plurality of memory controllers and a memory device group controlled by each memory controller.

As described with reference to FIG. 3, a first memory device group 100_1 may include a plurality of memory devices connected to a first memory controller 200_1 through a channel. A second memory device group 100_2 may include a plurality of memory devices connected to a second memory controller 200_2 through a channel.

The first memory controller 200_1 may be a main controller that communicates with the host 300 and controls a sub controller, which may be the second memory controller 200_2. The first memory controller 200_1 may control an operation of the first memory device group 100_1. The first memory controller 200_1 may control an operation of the second memory device group 100_2 through the second memory controller 200_2. For example, the first memory controller 200_1 may generate a command according to a request of the host 300, and selectively provide the generated command to any one of the first memory device group 100_1 and the second memory controller 200_2. The second memory controller 200_2 may control the operation of the second memory device group 100_2 based on the command received from the first memory controller 200_1.

The first memory controller 200_1 may manage map data of the first memory device group 100_1 and map data of the second memory device group 100_2.

Specifically, the first memory controller 200_1 may store a first mapping table corresponding to the first memory device group 100_1 and a second mapping table corresponding to the second memory device group 100_2. The first memory controller 200_1 may manage the first mapping table and the second mapping table by different address mapping methods. The first mapping table and the second mapping table may have different mapping units. For example, the first mapping table may configure each entry of the mapping table in a page unit, and the second mapping table may configure each entry of the mapping table in a zone unit. A zone may be a physical area, the size of which is larger than that of a page. For example, a zone may correspond to at least two pages. For example, the zone may correspond to a single block or a group of blocks. The size of the physical area corresponding to the zone may be various. Thus, an entry in the second mapping table may be to one or more specific blocks.

The first memory controller 200_1 may receive the request and the logical address from the host 300. The request may be a read request or a write request. The first memory controller 200_1 may determine which of the first memory device group 100_1 and the second memory device group 100_2 performs an operation according to the request of the host 300.

Specifically, the first memory controller 200_1 may select a memory device group to perform the write operation based on the logical address received from the host 300.

In an embodiment, a logical address range corresponding to each memory device group may be set. A first logical address range may correspond to the first memory device group 100_1, and a second logical address range may correspond to the second memory device group 100_2.

When the logical address received from the host 300 is in the first logical address range, the first memory controller 200_1 may control the first memory device group 100_1 to perform the operation according to the request of the host 300. When the logical address is in the second logical address range, the first memory controller 200_1 may control the second memory controller 200_2 so that the second memory device group 100_2 performs the write operation according to the request of the host 300.

In another embodiment, the first memory controller 200_1 may determine whether data input from the host 300 is random write data or sequential write data based on the logical address provided with the write request. When the data input from the host 300 is random write data, the first memory controller 200_1 may control the first memory device group 100_1 to perform the operation according to the request of the host 300. When the input data is sequential write data, the first memory controller 200_1 may control the second memory controller 200_2 so that the second memory device group 100_2 to perform the write operation according to the request of the host 300.

The first memory controller 200_1 may select a memory device group to perform the read operation based on the logical address received from the host 300. The first memory controller 200_1 may control the memory device group corresponding to the mapping table including the received logical address to perform the read operation.

For example, when the first mapping table includes the received logical address, the first memory controller 200_1 may control the first memory device group 100_1 to perform the read operation according to the received request. When the second mapping table includes the received logical address, the first memory controller 200_1 may control the second memory controller 200_2 so that the second memory device group 100_2 performs the read operation according to the received request. The second memory controller 200_2 may be a sub controller communicating with the host 300 through the first memory controller 200_1. The second memory controller 200_2 may control the operation of the second memory device group 100_2 based on the command received from the first memory controller 200_1.

In FIG. 4A, there is one main controller and one sub controller, but the storage device 50 is not limited to that arrangement. In various embodiments, a plurality of sub controllers may be connected to one main controller.

Referring to FIG. 3, when only one memory controller 200 communicates with the host 300, the number of memory devices that may be connected to the memory controller 200 through the channel may be limited. In addition, as the number of memory devices connected to one channel increases, performance of the storage device may decrease due to a limitation of a bus bandwidth. Therefore, there may be a limitation in terms of storage capacity expansion of the storage device when only one memory controller is used.

In contrast, according to an embodiment of the present disclosure, expanding capacity of the storage device may be easily done without decreasing the performance of the storage device by controlling the memory devices through a plurality of controllers. As the number of controllers increases, the total storage capacity of the storage device may also increase without increasing the number of memory devices connected to one channel.

To this end, the storage device may include the main controller communicating with the host and the sub controller communicating with the host through the main controller, and the main controller and the sub controller may be connected in a cascade structure. In an embodiment, each controller and the memory device group controlled by the controller may be designed in a system on chip (SoC) structure.

According to an embodiment of the present disclosure, the main controller may generate the command according to the request of the host 300, and may provide the command to the memory device group controlled by the main controller or to the sub controller. In addition, the main controller may manage the map data of each memory device group included in the storage device. The sub controller may control the directly connected memory device group based on the command received from the main controller.

The main controller may manage the memory device group controlled by each controller in different address mapping methods. For example, the main controller may manage the mapping table of the memory device group controlled by the main controller in the page unit, and may manage the mapping table of the memory device group controlled by the sub controller in the zone unit.

The main controller may control the memory device group corresponding to the logical address range to perform the operation according to the request of the host 300 according to whether the logical address received from the host 300 is included in the set logical address range.

In addition, the main controller may determine whether the data input from the host 300 is random write data or sequential write data based on the logical address received from the host 300. The main controller may control the memory device group directly controlled by the main controller to store the random write data and the memory device group controlled via the sub controller to store the sequential write data. That is, data that is expected to be frequently accessed may be stored in the memory device group controlled by the main controller, and large capacity data may be stored in the memory device group controlled via the sub controller.

Through such a method, a data input/output operation between the host 300 and the storage device 50 and a management operation of the data and the map data of the storage device 50 may be efficiently performed. In addition, efficient expansion of the storage capacity is possible without decreasing the performance of the storage device due to the limitation of the bus bandwidth, by increasing the number of sub controllers connected to the main controller rather than increasing the number of memory devices connected to the memory controller through one channel.

FIG. 4B is a diagram for describing the configuration and the operation of the storage device according to an embodiment.

Referring to FIG. 4B, the storage device 50 may include a plurality of memory controllers and a memory device group controlled by each memory controller.

The first memory controller 200_1, the second memory controller 200_2, the first memory device group 100_1, and the second memory device group 100_2 are as described with reference to FIG. 4A.

In an embodiment, one main controller may control at least one sub controller. Specifically, the main controller may control a memory device group controlled by each sub controller through the corresponding sub controller.

In FIG. 4B, the first memory controller 200_1, which is the main controller, may control second to n-th (n is a natural number equal to or greater than 1) memory controllers 200_2 to 200_n which are the sub controllers. The second to n-th sub memory controllers 200_2 to 200_n, may control second to n-th memory device groups 100_2 to 100_n, respectively. The first memory controller 200_1 may directly control the first memory device group 100_1.

In an embodiment, the memory device group controlled by the main controller and the memory device group(s) controlled by the sub controller(s) may be managed in different address mapping methods.

For example, the second to n-th memory device groups 100_2 to 100_n may be managed in the same address mapping method. The first memory device group 100_1 may be managed in an address mapping method different from that of the second to n-th memory device groups 100_2 to 100_n. The first memory controller 100_1 may store first to n-th mapping table. The first mapping table may be managed by first mapping method. The second to n-th mapping table may be managed by second mapping method. The first mapping method and the second mapping method have different mapping unit sizes. In an embodiment, the second to n-th mapping table may be managed by each corresponding mapping method.

Each sub controller is configured and operated as described with reference to FIG. 4A.

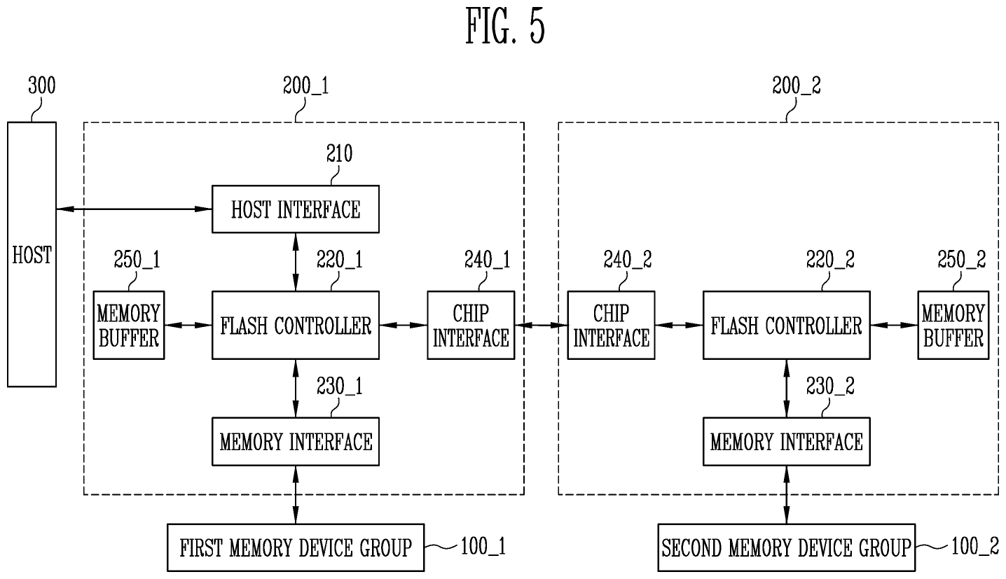

FIG. 5 is a diagram for describing a structure of the storage device of FIG. 4A according to an embodiment.

Referring to FIG. 5, the first memory controller 200_1 may include a host interface 210, a flash controller 220_1, a memory interface 230_1, a chip interface 240_1, and a memory buffer 250_1.

The host interface 210 may perform communication with the host 300 and the first memory controller 200_1. The flash controller 220_1 may control overall operation of the first memory controller 200_1 and operation of the first memory device group 100_1. The flash controller 220_1 may control the first memory device group 100_1 to perform an operation according to the request of the host 300. The flash controller 220_1 may control the second memory controller 200_2 so that the second memory device group 100_2 performs the operation according to the request of the host 300. The flash controller 220_1 may provide the command generated by the host 300 to the second memory controller 200_2.

The memory interface 230_1 may perform communication with the first memory device group 100_1 and the first memory controller 200_1. The chip interface 240_1 may communicate with the chip interface 240_2 and perform communication between the first memory controller 200_1 and the second memory controller 200_2. The memory buffer 250_1 may be used as a memory for performing an operation of the flash controller 220_1. The memory buffer 250_1 may store the map data corresponding to the first memory device group 100_1 and the second memory device group 100_2.

The second memory controller 200_2 may include a flash controller 220_2, a memory interface 230_2, a chip interface 240_2, and a memory buffer 250_2.

The flash controller 220_2 may control overall operation of the second memory controller 200_2 and operation of the second memory device group 100_2. The flash controller 220_2 may control the operation of the second memory device group 100_2 based on a command received from the first memory controller 200_1. The memory interface 230_2 may perform communication with the second memory device group 100_2 and the second memory controller 200_2. The chip interface 240_2 may communicate with the chip interface 240_1. The memory buffer 250_2 may be used as a memory for performing an operation of the flash controller 220_2. In various embodiments, the memory buffer 250_2 may store an additional mapping table for translation between zone unit address received from the first memory controller 200_1 and page unit address inside the second memory device group 100_2.

In FIG. 5, the first memory controller 200_1 is shown as the main controller and the second memory controller 200_2 is shown as the only sub controller. However, the number of sub controllers connected to the main controller is not limited to one.

As described with reference to FIG. 4B, when more than one sub controller is connected to one main controller, a structure and an operation of each sub controller may be the same.

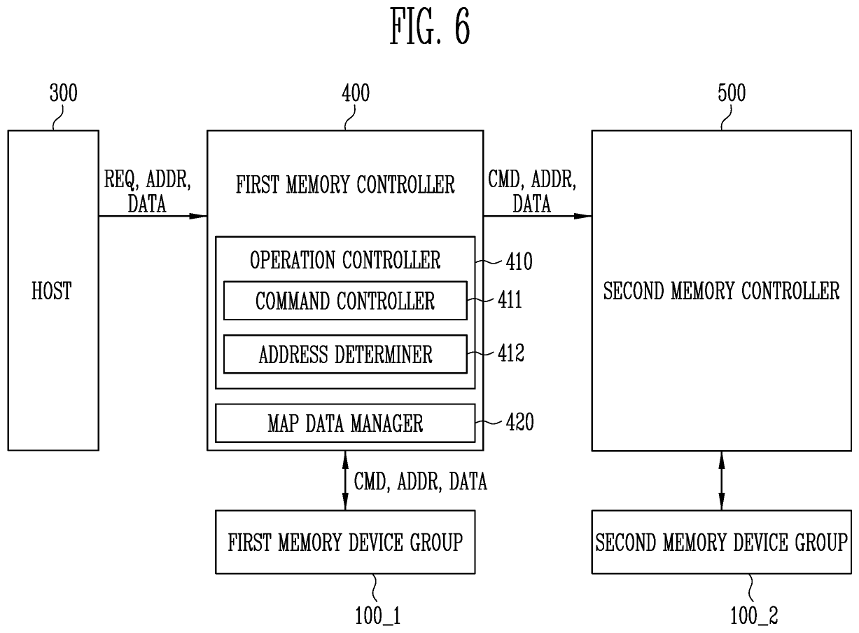

FIG. 6 is a diagram for describing the structure of the storage device of FIG. 4A according to another embodiment.

Referring to FIG. 6, the host 300 and the memory device groups 100_1 and 100_2 are configured and operate as described with respect to FIG. 4A. Therefore, description focuses on a first memory controller 400 and a second memory controller 500. The first memory controller 400 may be a main controller and the second memory controller 500 may be a sub controller.

An operation of the first memory controller 400 may be implemented by the first memory controller 200_1 of FIG. 5. An operation of the second memory controller 500 may be implemented by the second memory controller 200_2 of FIG. 5.

The first memory controller 400 may include an operation controller 410 and a map data manager 420.

The operation controller 410 may receive a request REQ associated with a write operation, an address ADDR, and data DATA from the host 300. The operation controller 410 may provide data DATA to the host 300 in response to a request REQ associated with a read operation.

The operation controller 410 may receive a write request for storing data in the memory device groups 100_1 and 100_2 from the host 300. The operation controller 410 may receive the write request, write data, and a logical address in which the write data is to be stored from the host 300. The operation controller 410 may generate a write command according to the write request.

The operation controller 410 may select a memory device group to perform the write operation according to the write command based on the logical address. The operation controller 410 may provide the write command and the write data to the selected memory device group.

In an embodiment, when the logical address is included in a first logical address range, the operation controller 410 may provide the write command and the write data to the first memory device group 100_1. When the logical address is included in a second logical address range, the operation controller 410 may provide the write command and the write data to the second memory controller 500. The second memory controller 500 may control the second memory device group 100_2 to store the write data based on the write command received from the operation controller 410.

In another embodiment, when the logical address corresponds to random write data, the operation controller 410 may provide the write command and the write data to the first memory device group 100_1. When the logical address corresponds to sequential write data, the operation controller 410 may provide the write command and the write data to the second memory controller 500. The second memory controller 500 may control the second memory device group 100_2 to store the write data based on the write command received from the operation controller 410.

The operation controller 410 may receive the read request for reading data stored in the memory device groups 100_1 and 100_2 from the host 300. The operation controller 410 may receive the read request and a logical address in which the data to be read is stored from the host 300. The operation controller 410 may generate a read command according to the read request.

The operation controller 410 may select a memory device group to perform the read operation according to the read command based on the logical address. The operation controller 410 may provide the read command to the selected memory device group.

When the logical address is included in the first mapping table, the operation controller 410 may provide the read command to the first memory device group 100_1. When the logical address is included in the second mapping table, the operation controller 410 may provide the read command to the second memory device group 100_2.

The operation controller 410 may provide read data obtained from the memory device group that performed the read operation according to the read command to the host 300 in response to the read request.

The operation controller 410 may include a command controller 411 and an address determiner 412.

The command controller 411 may generate and queue the command according to the request REQ received from the host 300. The command controller 411 may provide the command generated according to the memory device group selected by the address determiner 412 to the first memory device group 100_1 or the second memory controller 500. For example, when the first memory device group 100_1 is selected, the command controller 411 may provide the generated command to the first memory device group 100_1. When the second memory device group 100_2 is selected, the command controller 411 may provide the generated command to the second memory controller 500.

The address determiner 412 may determine which memory device group performs the operation according to the request REQ of the host 300 based on the logical address received from the host 300.

In an embodiment, a logical address range corresponding to each memory device group may be set. When the logical address is included in a first logical address range, the address determiner 412 may select the first memory device group 100_1 as the memory device group that performs the operation according to the request REQ of the host 300. When the logical address is included in a second logical address range, the address determiner 412 may select the second memory device group 100_2 as the memory device group that performs the operation according to the request REQ of the host 300.

In another embodiment, the address determiner 412 may determine whether the write data is random write data or sequential write data based on the received logical address. When the logical address corresponds to random write data, the address determiner 412 may select the first memory device group 100_1 as the memory device group that performs the operation according to the request REQ of the host 300. When the logical address corresponds to sequential write data, the address determiner 412 may select the second memory device group 100_2 as the memory device group that performs the operation according to the request REQ of the host 300.

The map data manager 420 may store and manage the map data corresponding to each of the memory device groups 100_1 and 100_2. For example, the map data manager 420 may store the first mapping table corresponding to the first memory device group 100_1 and the second mapping table corresponding to the second memory device group 100_2. The map data manager 420 may manage the first mapping table and the second mapping table by different address mapping methods. A mapping unit of the first mapping table may be smaller than that of the second mapping table. For example, the first mapping table may configure each entry in a page unit, and the second mapping table may configure each entry in a zone unit. A size of a zone may be variously set according to a map data management policy. In an embodiment, the zone may be a physical area greater than a page.

The size of the zone may be a set number of blocks, i.e., one block or a group of blocks.

The map data manager 420 may generate the map data based on the logical address received from the host 300. The map data manager 420 may provide the physical address converted based on the logical address to the memory device group or the memory controller.

For example, the map data manager 420 may receive the logical address to store the write data from the host 300. When the write data is stored in the first memory device group 100_1, the map data manager 420 may store the mapping data generated based on the logical address and the physical address in which the write data is to be stored in the first memory device group 100_1, in the first mapping table. The map data manager 420 may provide the physical address in which the write data is to be stored to the first memory device group 100_1. When the write data is stored in the second memory device group 100_2, the map data manager 420 may store the mapping data generated based on the logical address and the physical address in which the write data is to be stored in the second memory device group 100_2, in the second mapping table. The map data manager 420 may provide the physical address at which the write data is to be stored to the second memory controller 500.

As another example, the map data manager 420 may receive from the host 300 a logical address indicating a storage region where read-requested data is stored. When data stored in the first memory device group 100_1 is read, the map data manager 420 may provide the physical address converted based on the logical address in the first mapping table to the first memory device group 100_1. When data stored in the second memory device group 100_2 is read, the map data manager 420 may provide the physical address converted based on the logical address in the second mapping table to the second memory controller 500.

The second memory controller 500 may receive the command and the write data from the operation controller 410, and may receive the physical address from the map data manager 420. The second memory controller 500 may control the second memory device group 100_2 to store data in a storage area indicated by the physical address based on the received command. The second memory controller 500 may control the second memory device group 100_2 to read the data stored in the storage area indicated by the physical address based on the received command. As described with reference to FIG. 4B, when more than one sub controller is connected to one main controller, the structure and the operation of each sub controller may be the same.

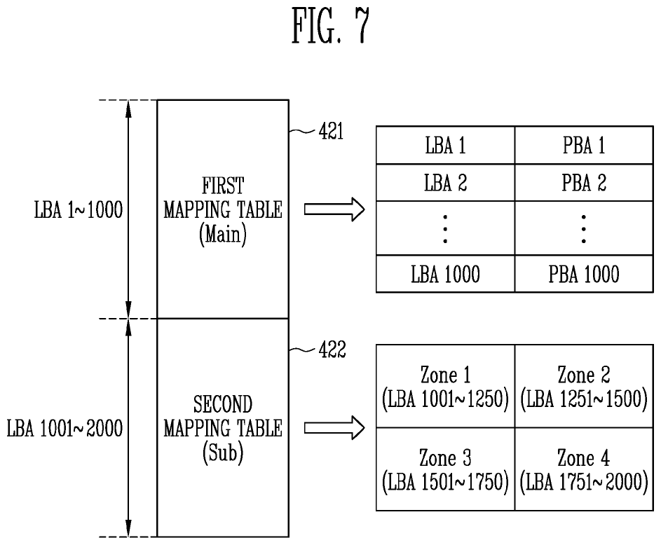

FIG. 7 is a diagram for describing the mapping table according to an embodiment.

Referring to FIGS. 6 and 7, a first mapping table 421 may correspond to the first memory device group 100_1 controlled by the main controller. A second mapping table 422 may correspond to the second memory device group 100_2 controlled by the sub controller.

In an embodiment, the logical address range corresponding to each memory device group may be set. A first logical address range corresponding to the first memory device group 100_1 may be LBA 1 to LBA 1000. A second logical address range corresponding to the second memory device group 100_2 may be LBA 1001 to LBA 2000. The ranges of the logical addresses are not limited to the above-described specifics.

The first mapping table 421 and the second mapping table 422 may be managed in different address mapping methods. In FIG. 6, the logical address of the first mapping table 421 may be mapped in the page unit. The logical address of the second mapping table 422 may be mapped in the zone unit.

Specifically, in the first mapping table 421, the logical addresses and the physical address of the page unit may be mapped with each other one-to-one. One logical address may be mapped with one physical address, and a size of a storage area indicated by one physical address may correspond to one page. For example, the logical address LBA 1 may be mapped with the physical address PBA 1.

In the second mapping table 422, the logical address and the physical address of the zone unit may be mapped with each other N-to-one (N is a natural number equal to or greater than 1). In FIG. 7, one zone may be mapped with 250 logical addresses, although this is merely an example. One zone may be mapped with any suitable number of logical addresses.

As described with reference to FIG. 4A, the first memory device group 100_1 may physically perform a read operation or a program operation in a page unit and an erase operation in a block unit. The first memory device group 100_1 may use the page unit mapping method. The second memory device group 100_2 may physically perform a read operation or a program operation in a page unit and an erase operation in a block unit. The second memory device group 100_2 may use the zone unit mapping method.

For example, the first memory controller 200_1 may receive logical addresses and a read request from the host 300. When the received logical addresses are included in the first mapping table, the first memory controller 200_1 may provide the first memory device group 100_1 with target physical addresses corresponding to the logical addresses in the first mapping table.

Since the first mapping table may be managed in the page unit, one physical address may indicate one physical page. The first memory device group 100_1 may read data stored in target physical pages corresponding to each of the target physical addresses, and provide the read data to the first memory controller 200_1. The first memory controller 200_1 may provide data read from target physical pages to the host 300.

For example, the first memory controller 200_1 may receive logical addresses and a read request from the host 300. When the received logical addresses are included in the second mapping table, the first memory controller 200_1 may provide the second memory controller 200_2 with an index of a target zone and offsets.

The target zone may correspond to the received logical addresses in the second mapping table. The index of the target zone may be obtained based on division with a size of the target zone for the logical addresses. For example, it is assumed that one target zone may include 250 physical pages and one physical page may correspond to one logical page, then the size of the target zone is 250. When a first logic address among the received logical address is LBA 1277, a quotient for LBA 1277 is 5. The quotient 5 may indicate a logical zone address corresponding to a logical address range in the second mapping table. Thus, the index of the target zone may be obtained by searching an index of zone mapped to the logical zone address 5 in the second mapping table.

The offsets may be obtained by calculating mod with the size of the target zone for the logical addresses. Thus, an offset for LBA 1277 is obtained by calculating mod with 250 for 1277, and the offset for LBA 1277 is 27. In other words, when the first memory controller 200_1 receives LBA 1277 from the host, the first memory controller 200_1 provides the second memory controller 200_2 with the index of the target zone corresponding the logical zone address 5 in the second mapping table and the offset 27 for LBA 1277. The second memory controller 200_2 may control the second memory device group 100_2 to read the 27th physical page included in the target zone.

In an embodiment, when one zone corresponds to one memory block. the mapping method in the second mapping table may be block mapping method. The size of the physical area corresponding to the zone is not limited to this embodiment.

The second memory controller 200_2 may control the second memory device to read the target memory block indicated by the index of the target zone. The second memory device group 100_2 may sequentially read data stored in an area selected by the offsets in the target memory block, and sequentially provide the read data to the second memory controller 200_2. The second memory controller 200_2 may provide data read from the target memory block to the first memory controller 200_1, and the first memory controller 200_1 may provide the read data to the host 300.

That is, since the zone unit is larger than the page unit, It may be advantageous that sequential data having a large size and being rarely read and written is stored in a second memory device group 100_2 and is managed by the zone unit mapping method. It may be advantageous that random data having a small size and being frequently read and written is stored in the first memory device group 100_1 and is managed by the page unit mapping method.

In an embodiment, the first memory controller 200_1 may receive write data and write requests from the host 300. When the write data is random data, the write data may be stored in the first memory device group 100_1 and managed by the page unit mapping method in the first mapping table. When the write data is sequential data, the write data may be stored in the second memory device group 100_2 and managed by the zone unit mapping method in the second mapping table.

A plurality of logical addresses may be mapped with one physical zone address.

For example, the second logical address range LBA 1001 to LBA 2000 may be divided into four zones. The logical addresses LBA 1001 to LBA 1250 may be mapped with a physical address Zone 1. The logical addresses LBA 1251 to LBA 1500 may be mapped with a physical address Zone 2. The logical addresses LBA 1501 to LBA 1750 may be mapped with a physical address Zone 3. The logical addresses LBA 1751 to LBA 200 may be mapped with a physical address Zone 4.

In an embodiment, when the first memory controller 200_1 receives logical addresses and a request from the host 300, the first memory controller 200_1 may provide an index of a target zone and offsets to the second memory controller 200_2. The index of the target zone may be obtained by searching an index of a zone mapped to a logical zone address corresponding to a logical address range in the second mapping table. The logical address range may include the logical addresses received from the host 300. The offsets may be obtained by calculating mod with a size of the target zone for the logical addresses received from the host 300.

When the logical address received from the host 300 is included in the first logical address range LBA 1 to LBA 1000, the main controller may store the mapping data generated based on the logical address in the first mapping table 421. When the logical address received from the host 300 is included in the second logical address range LBA 1001 to LBA 2000, the main controller may store the mapping data generated based on the logical address in the second mapping table 422. As described with reference to FIG. 4B, when more than one sub controller is connected to one main controller, the mapping table may be generated for each memory device group controlled by each sub controller. The mapping table for each memory device group is stored in the main controller and managed by the main controller. The mapping table corresponding to each memory device group controlled by any sub controller may be managed by the same address mapping method. The mapping table corresponding to the memory device group(s) controlled by the main controller and the mapping table corresponding to the memory device group(s) controlled by the sub controller may be managed by different address mapping methods.

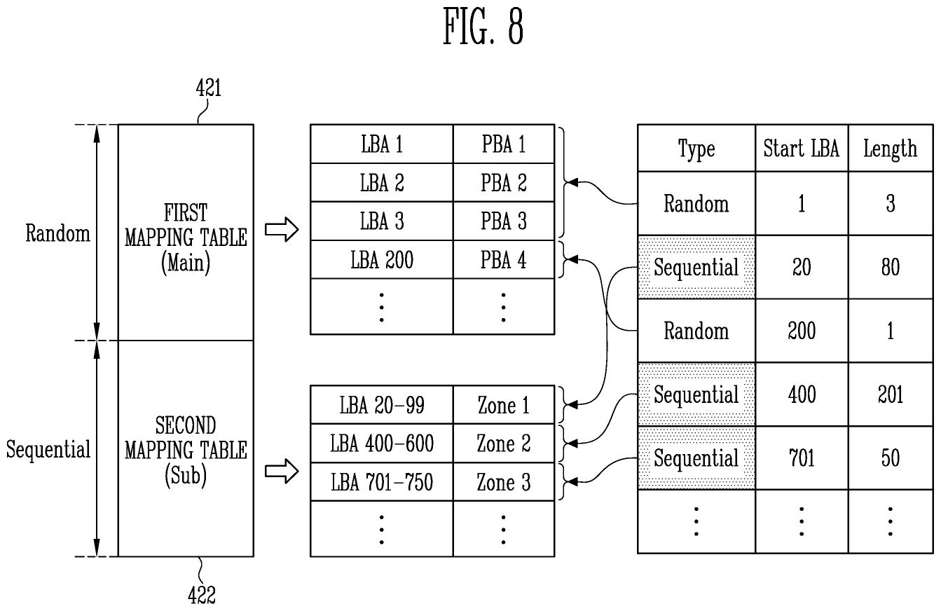

FIG. 8 is a diagram for describing the mapping table according to another embodiment.

Referring to FIGS. 6 and 8, the first mapping table 421 may correspond to the first memory device group 100_1 controlled by the main controller. The second mapping table 422 may correspond to the second memory device group 100_2 controlled by the sub controller.

As described with reference to FIG. 4B, when more than one sub controller is connected to one main controller, the mapping table may be generated for each memory device group that is controlled by each sub controller. The mapping table corresponding to the memory device group(s) may be managed by the same address mapping method. The mapping table corresponding to the memory device group(s) controlled by the main controller and the mapping table corresponding to the memory device group(s) controlled by the sub controller may be managed by different address mapping methods.

As described with reference to FIG. 7, the first mapping table 421 and the second mapping table 422 may be managed by different address mapping methods. In the first mapping table 421, the logical address may be mapped in the page unit. In the second mapping table 422, the logical address may be mapped in the zone unit.

The main controller may determine whether the logical address corresponds to random write data or sequential write data based on a length (or the number of successive logical addresses) received from the host 300. In FIG. 8, when the length of the logical address string, i.e., number of logical addresses, is equal to or greater than 10, the main controller may determine that the logical address corresponds to sequential write data. When the length of the logical address string is less than 10, the main controller may determine that the logical address corresponds to random write data. The specific length of the logical address string for determining whether the logical address is random or sequential write data is not limited to 10; any suitable length may be used.

The main controller may control the first memory device group 100_1 to store random write data. The main controller may control the sub controller so that the second memory device group 100_2 stores sequential write data. This is to store voluminous data, which is typically includes sequential write data, in the memory device group(s) controlled by the sub controller(s), as expanded storage capacity may be obtained by increasing the number of sub controllers connected to the main controller.

When the logical address corresponds to random write data, the main controller may store the mapping data generated based on the logical address in the first mapping table 421. When the logical address corresponds to sequential write data, the main controller may store the mapping data generated based on the logical address in the second mapping table 422.

For example, the write data and the logical addresses LBA 1 to LBA 3 may be received from the host 300. Since the length of the logical address string is 3, the logical addresses may correspond to random write data. Therefore, mapping data generated based on the logical addresses LBA 1 to LBA 3 may be stored in the first mapping table 421.

The write data and the logical addresses LBA 20 to LBA 99 may be received from the host 300. Since the length of the logical address string is 80, the logical addresses may correspond to sequential write data. Therefore, mapping data generated based on the logical addresses LBA 20 to LBA 99 may be stored in the second mapping table 422. A physical address mapped with the logical addresses LBA 20 to LBA 99 may be Zone 1. The mapping data includes a start logical address LBA 20, an offset for the start logical address LBA 20 and 80 that is the length of the logical address string. The offset for the start logical address LBA 20 is determined based on a program sequence in Zone 1. Write data corresponding to LBA 20 might be 1st programed in Zone 1, thus the offset for the start logical address LBA 20 is 1. Offsets for LBA 21 to LBA 99 may be calculated with reference to the offset for the start logical address LBA 20. The offsets for LBA 21 to LBA 99 may be 2 to 80.

It is assumed that write data write data and the logical addresses LBA 130 to LBA 150 may be received from the host 300. Since the length of the logical address string is 21, the logical addresses LBA 130 to LBA 150 may correspond to sequential write data. Therefore, mapping data generated based on the logical addresses LBA 130 to LBA 150 may be stored in the second mapping table 422. A physical address mapped with the logical addresses LBA 130 to LBA 150 may be Zone 1. The mapping data includes a start logical address LBA 130, an offset for the start logical address LBA 130 and 21 that is the length of the logical address string. The offset for the start logical address LBA 130 is determined based on a program sequence in Zone 1. Write data corresponding to LBA 130 might be 81st programed in Zone 1, thus the offset for the start logical address LBA 130 is 81. The offset for the start logical address LBA 130 may be obtained by referencing previous mapping data corresponding to Zone 1 in the second mapping table. Offsets for LBA 131 to LBA 150 may be calculated with reference to the offset for the start logical address LBA 81. The offsets for LBA 131 to LBA 150 may be 82 to 101.

As described with reference to FIG. 4A, in an embodiment, when the first memory controller 200_1 receives logical addresses and a request from the host 300, the first memory controller 200_1 may provide an index of a target zone and offsets for the received logical address to the second memory controller 200_2. The offsets may be calculated based on an offset for a start logical address of the received logical address and the length of the received logical address string. The second memory controller 200_2 may control the second memory device group 100_2 to read an area selected by the offsets in the target zone.

The write data and the logical address LBA 200 may be received from the host 300. Since the length of the logical address string is 1, the logical address may correspond to the random write data. Therefore, mapping data generated based on the logical address LBA 200 may be stored in the first mapping table 421.

When mapping data is stored in a specific mapping table according to which logical address range the logical address is included in, the mapping data is stored in the specific mapping table according to whether the logical address corresponds to the random write data or the sequential write data, as exemplified by FIGS. 7 and 8.

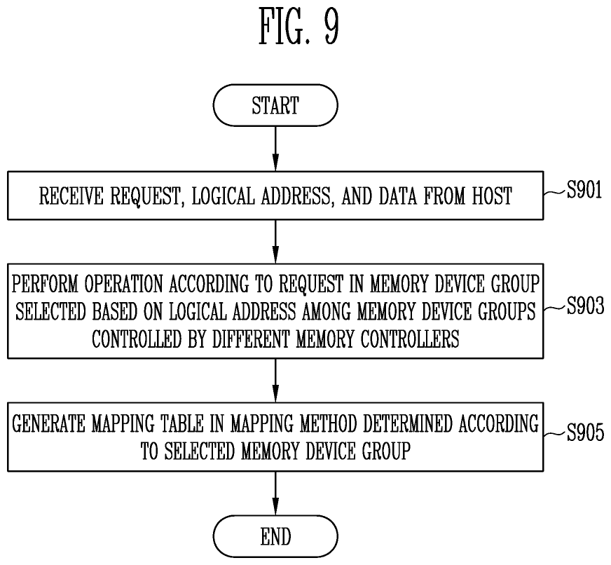

FIG. 9 is a flowchart for describing the operation of the storage device of FIG. 4A.

Referring to FIG. 9, in step S901, the storage device may receive a request, logical address(es), and data from the host.

For example, the storage device may receive from the host a write request, write data and the logical address(es) at which the write data is to be stored. Alternatively, the storage device may receive from the host a read request and the logical address(es) indicating a storage region at which read-requested data is stored.

In step S903, an operation according to a request may be performed in a memory device group selected based on the logical address(es), among memory device groups controlled by different memory controllers, in the storage device.

For example, when the logical address(es) is/are included in the first logical address range, the operation may be performed in the memory device group controlled by the main controller, and when the logical address(es) is/are included in the second logical address range, the operation may be performed in the memory device group controlled by the sub controller. Alternatively, when the logical address(es) corresponds to random write data, the operation may be performed in the memory device group controlled by the main controller, and when the logical address corresponds to sequential write data, the operation may be performed in the memory device group controlled by the sub controller.

In step S905, the storage device may generate the mapping table by a mapping method determined according to the selected memory device group. For example, the storage device may generate the mapping table in the page unit when the memory device group is controlled by the main controller, and generate the mapping table in the zone unit when the memory device group is controlled by the sub controller.

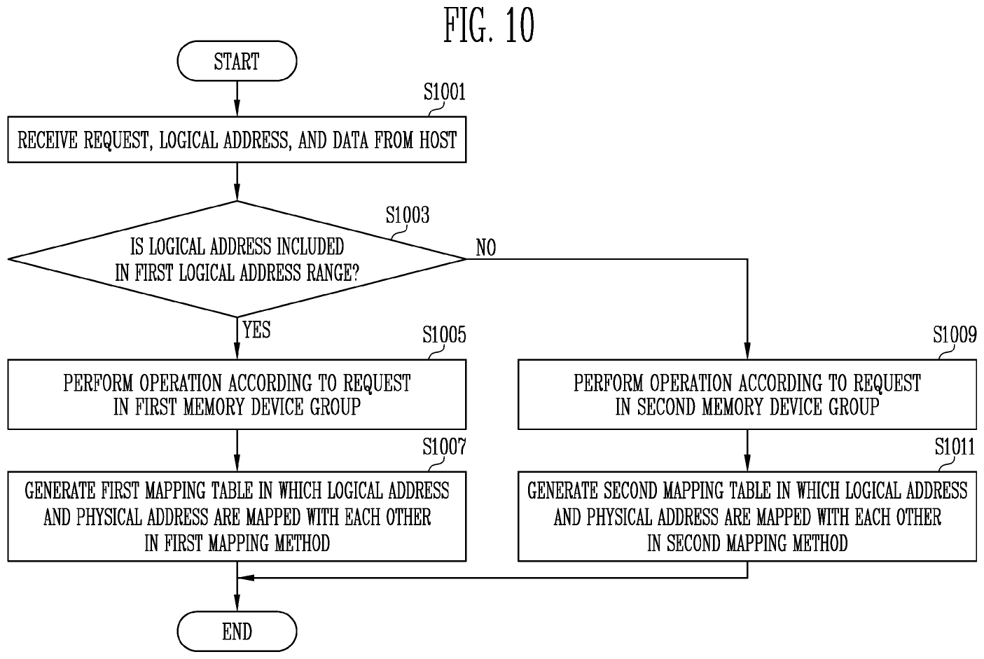

FIG. 10 is a flowchart for describing the operation of the storage device of FIG. 4A according to an embodiment.

Referring to FIG. 10, in step S1001, the storage device may receive a request, logical address, and data from the host. The storage device may include the main controller, the sub controller, the first memory device group controlled by the main controller, and the second memory device group controlled by the sub controller. However, the number of controllers and memory device groups included in the storage device is not limited to that configuration.

In step S1003, the storage device may determine whether the received logical address is included in a first logical address range. If so, the process proceeds to step S1005, and when the logical address is not included in the first logical address range but is included in a second logical address range, the process proceeds to step S1009. The first logical address range may correspond to the first memory device group, and the second logical address range may correspond to the second memory device group.

In step S1005, the operation according to the request of the host may be performed in the first memory device group.

In step S1007, the first mapping table in which the logical address and the physical address are mapped with each other according to the first mapping method may be generated. The first mapping table may correspond to the first memory device group. The first mapping method may be a page unit mapping method.

In step S1009, the operation according to the request of the host may be performed in the second memory device group.

In step S1011, the second mapping table in which the logical address and the physical address are mapped with each other according to the second mapping method may be generated. The second mapping table may correspond to the second memory device group. The second mapping method may be a zone unit mapping method.

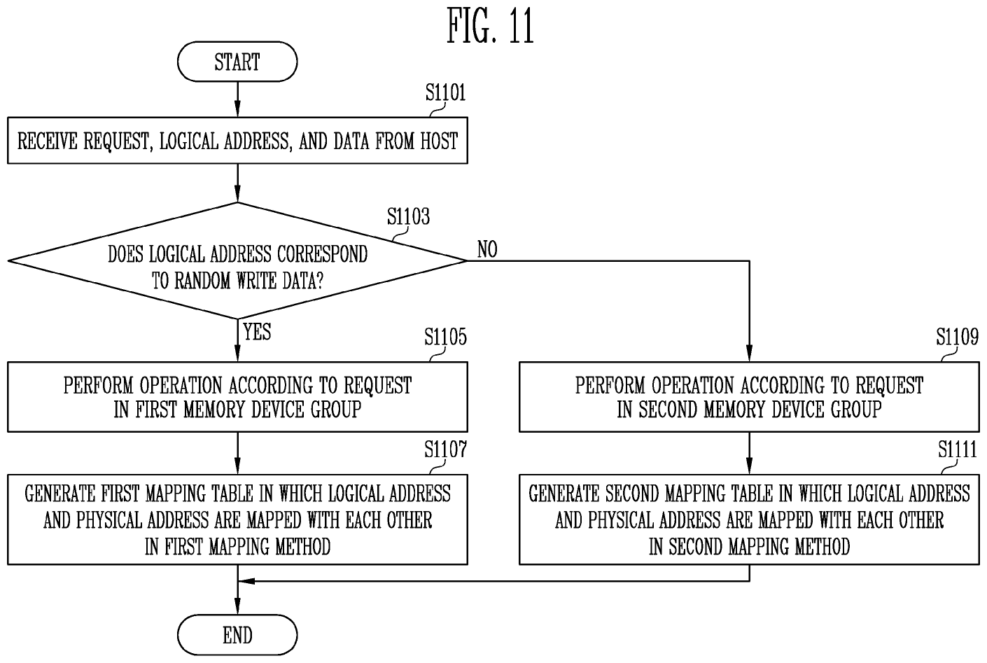

FIG. 11 is a flowchart for describing the operation of the storage device of FIG. 4A according to another embodiment.

Referring to FIG. 11, in step S1101, the storage device may receive a request, logical address(es), and data from the host. The storage device may include the main controller, the sub controller, the first memory device group controlled by the main controller, and the second memory device group controlled by the sub controller. However, the number of controllers and memory device groups included in the storage device is not limited to that configuration.

In step S1103, the storage device may determine whether the received logical address(es) corresponds to random write data. As a result of the determination, when the logical address(es) corresponds to random write data, the process proceeds to step S1105, and when the logical address(es) corresponds to sequential write data, the process proceeds to step S1109. Specifically, the storage device may determine whether the logical address(es) corresponds to random write data based on the length of the received logical address string (the number of successive logical addresses).

In step S1105, the operation according to the request of the host may be performed in the first memory device group.

In step S1107, the first mapping table in which the logical address(es) and the physical address(es) are mapped according to the first mapping method may be generated. The first mapping table may correspond to the first memory device group. The first mapping method may be a page unit mapping method.

In step S1109, the operation according to the request of the host may be performed in the second memory device group.

In step S1111, the second mapping table in which the logical address(es) and the physical address(es) are mapped according to the second mapping method may be generated. The second mapping table may correspond to the second memory device group. The second mapping method may be a zone unit mapping method.

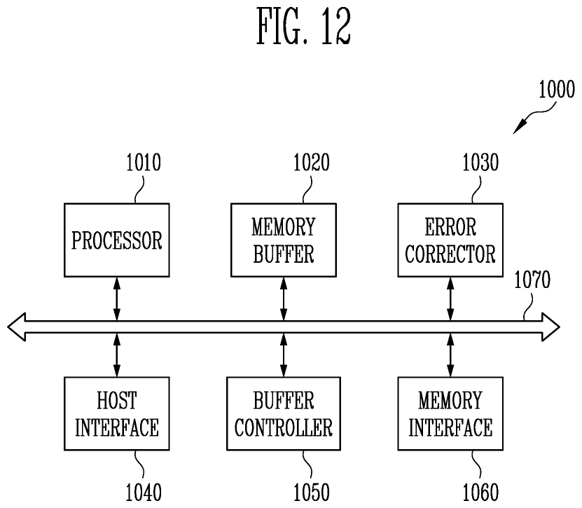

FIG. 12 is a diagram for describing another embodiment of the memory controller of FIG. 1.

Referring to FIG. 12, the memory controller 1000 is connected to a host and the memory device. The memory controller 1000 is configured to access the memory device in response to the request from the host, which may be an external device. For example, the memory controller 1000 is configured to control the write, read, erase, and background operations of the memory device. The memory controller 1000 is configured to provide an interface between the memory device and the host. The memory controller 1000 is configured to drive firmware for controlling the memory device.

The memory controller 1000 may include a processor 1010, a memory buffer 1020, an error corrector (ECC) 1030, a host interface 1040, a buffer control circuit 1050, a memory interface 1060, and a bus 1070.

The bus 1070 may be configured to provide a channel between components of the memory controller 1000.

The processor 1010 may control overall operation of the memory controller 1000 and may perform a logical operation. The processor 1010 may communicate with the host through the host interface 1040 and communicate with the memory device through the memory interface 1060. In addition, the processor 1010 may communicate with the memory buffer 1020 through the buffer controller 1050. The processor 1010 may control an operation of the storage device using the memory buffer 1020 as an operation memory, a cache memory, or a buffer memory.

The processor 1010 may perform a function of a flash translation layer (FTL). The processor 1010 may convert a logical block address (LBA) provided by the host into a physical block address (PBA) through the flash translation layer (FTL). The flash translation layer (FTL) may receive the logical block address (LBA) using a mapping table and convert the logical block address (LBA) into the physical block address (PBA). An address mapping method of the flash translation layer may include various methods according to a mapping unit. A representative address mapping method includes a page mapping method, a block mapping method, and a hybrid mapping method.

The processor 1010 is configured to randomize data received from the host. For example, the processor 1010 may randomize the data received from the host using a randomizing seed. The randomized data is provided to the memory device as data to be stored and is programmed to the memory cell array.

The processor 1010 is configured to de-randomize data received from the memory device during the read operation. For example, the processor 1010 may de-randomize the data received from the memory device using a de-randomizing seed. The de-randomized data may be output to the host.

In an embodiment, the processor 1010 may perform the randomization and the de-randomization by driving software or firmware.

The memory buffer 1020 may be used as an operation memory, a cache memory, or a buffer memory of the processor 1010. The memory buffer 1020 may store codes and commands executed by the processor 1010. The memory buffer 1020 may store data processed by the processor 1010. The memory buffer 1020 may include a static RAM (SRAM) or a dynamic RAM (DRAM).

The error corrector 1030 may perform error correction. The error corrector 1030 may perform error correction encoding (ECC encoding) based on data to be written to the memory device through memory interface 1060. The error correction encoded data may be transferred to the memory device through the memory interface 1060. The error corrector 1030 may perform error correction decoding (ECC decoding) on the data received from the memory device through the memory interface 1060. For example, the error corrector 1030 may be included in the memory interface 1060 as a component of the memory interface 1060.

The host interface 1040 is configured to communicate with an external host under control of the processor 1010. The host interface 1040 may be configured to perform communication using at least one of various communication methods such as a universal serial bus (USB), a serial AT attachment (SATA), a serial attached SCSI (SAS), a high speed interchip (HSIC), a small computer system interface (SCSI), a peripheral component interconnection (PCI express), a nonvolatile memory express (NVMe), a universal flash storage (UFS), a secure digital (SD), a multimedia card (MMC), an embedded MMC (eMMC), a dual in-line memory module (DIMM), a registered DIMM (RDIMM), and/or a load reduced DIMM (LRDIMM).

The buffer controller 1050 is configured to control the memory buffer 1020 under the control of the processor 1010.

The memory interface 1060 is configured to communicate with the memory device under the control of the processor 1010. The memory interface 1060 may communicate a command, an address, and data with the memory device through a channel.

In an embodiment, the memory controller 1000 may not include the memory buffer 1020 and the buffer controller 1050. Either or both of these components may be external to the memory controller 1000. Alternatively, the functionality of either or both of these components may be distributed among other components of the memory controller 1000.

For example, the processor 1010 may control the operation of the memory controller 1000 using codes. The processor 1010 may load the codes from a non-volatile memory device (for example, a read only memory) provided inside the memory controller 1000. As another example, the processor 1010 may load the codes from the memory device through the memory interface 1060.

For example, the bus 1070 of the memory controller 1000 may be divided into a control bus and a data bus. The data bus may be configured to transmit data within the memory controller 1000 and the control bus may be configured to transmit control information such as a command and an address within the memory controller 1000. The data bus and the control bus may be separated from each other and may not interfere with each other or affect each other. The data bus may be connected to the host interface 1040, the buffer controller 1050, the error corrector 1030, and the memory interface 1060. The control bus may be connected to the host interface 1040, the processor 1010, the buffer controller 1050, the memory buffer 1202, and the memory interface 1060.

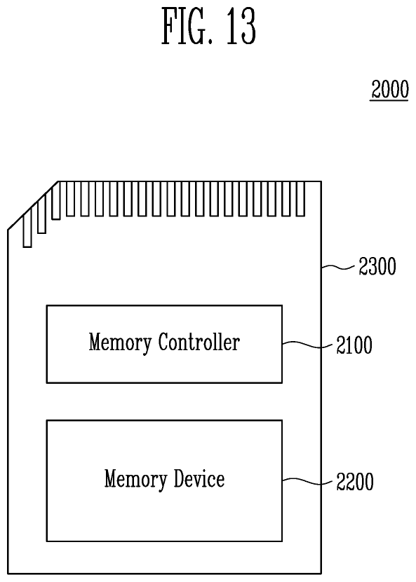

FIG. 13 is a block diagram illustrating a memory card system to which the storage device is applied according to an embodiment of the present disclosure.

Referring to FIG. 13, the memory card system 2000 includes a memory controller 2100, a memory device 2200, and a connector 2300.

The memory controller 2100 is connected to the memory device 2200. The memory controller 2100 is configured to access the memory device 2200. For example, the memory controller 2100 may be configured to control read, write, erase, and background operations of the memory device 2200. The memory controller 2100 is configured to provide an interface between the memory device 2200 and a host. The memory controller 2100 is configured to drive firmware for controlling the memory device 2200. The memory controller 2100 may be implemented identically to the memory controller 200 described with reference to FIG. 1.

For example, the memory controller 2100 may include components such as a random access memory (RAM), a processor, a host interface, a memory interface, and an error corrector.

The memory controller 2100 may communicate with an external device through the connector 2300. The memory controller 2100 may communicate with an external device (for example, the host) according to a specific communication standard. For example, the memory controller 2100 is configured to communicate with an external device through at least one of various communication standards such as a universal serial bus (USB), a multimedia card (MMC), an embedded MMC (MCM), a peripheral component interconnection (PCI), a PCI express (PCI-E), an advanced technology attachment (ATA), a serial-ATA, a parallel-ATA, a small computer system interface (SCSI), an enhanced small disk interface (ESDI), integrated drive electronics (IDE), FireWire, a universal flash storage (UFS), Wi-Fi, Bluetooth, and/or an NVMe. For example, the connector 2300 may be defined by at least one of the various communication standards described above.

For example, the memory device 2200 may be configured as any of various non-volatile memory elements such as an electrically erasable and programmable ROM (EEPROM), a NAND flash memory, a NOR flash memory, a phase-change RAM (PRAM), a resistive RAM (ReRAM), a ferroelectric RAM (FRAM), and/or a spin-torque magnetic RAM (STT-MRAM).

The memory controller 2100 and the memory device 2200 may be integrated into one semiconductor device to configure a memory card, such as a PC card (personal computer memory card international association (PCMCIA)), a compact flash card (CF), a smart media card (SM or SMC), a memory stick, a multimedia card (MMC, RS-MMC, MMCmicro, or eMMC), an SD card (SD, miniSD, microSD, or SDHC), and/or a universal flash storage (UFS).

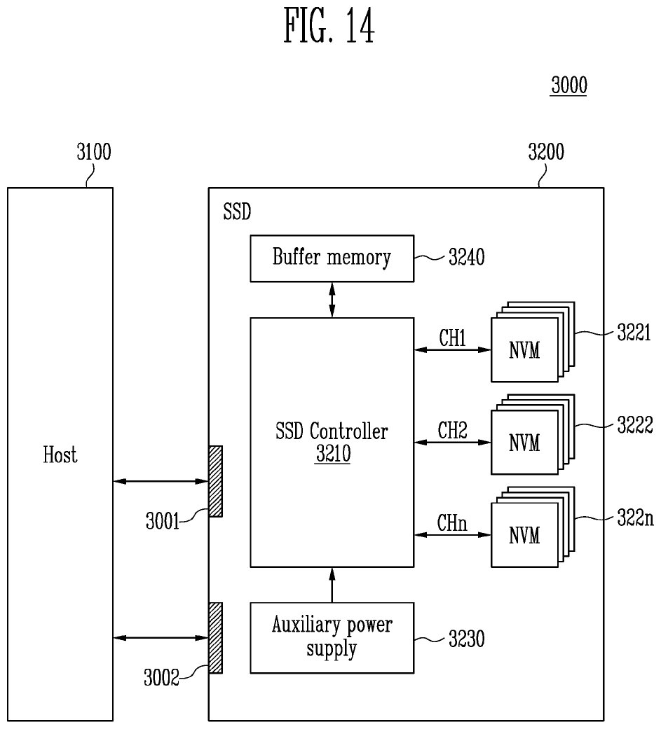

FIG. 14 is a block diagram illustrating a solid state drive (SSD) system to which the storage device according to an embodiment of the present disclosure is applied.

Referring to FIG. 14, the SSD system 3000 includes a host 3100 and an SSD 3200. The SSD 3200 exchanges a signal SIG with the host 3100 through a signal connector 3001 and receives power PWR through a power connector 3002. The SSD 3200 includes an SSD controller 3210, a plurality of flash memories 3221 to 322n, an auxiliary power device 3230, and a buffer memory 3240.

According to an embodiment of the present disclosure, the SSD controller 3210 may perform the function of the memory controller 200 described with reference to FIG. 1.

The SSD controller 3210 may control the plurality of flash memories 3221 to 322n in response to the signal SIG received from the host 3100. For example, the signal SIG may be based on an interface between the host 3100 and the SSD 3200. For example, the signal SIG may be defined by at least one of various interfaces such as a universal serial bus (USB), a multimedia card (MMC), an embedded MMC (MCM), a peripheral component interconnection (PCI), a PCI express (PCI-E), an advanced technology attachment (ATA), a serial-ATA, a parallel-ATA, a small computer system interface (SCSI), an enhanced small disk interface (ESDI), integrated drive electronics (IDE), FireWire, a universal flash storage (UFS), Wi-Fi, Bluetooth, and/or an NVMe.

The auxiliary power device 3230 is connected to the host 3100 through the power connector 3002. The auxiliary power device 3230 may receive the power from the host 3100 and may charge the power. The auxiliary power device 3230 may provide power of the SSD 3200 when power supply from the host 3100 is not smooth. For example, the auxiliary power device 3230 may be positioned in the SSD 3200 or may be positioned outside the SSD 3200. For example, the auxiliary power device 3230 may be positioned on a main board and may provide auxiliary power to the SSD 3200.

The buffer memory 3240 operates as a buffer memory of the SSD 3200. For example, the buffer memory 3240 may temporarily store data received from the host 3100 or data received from the plurality of flash memories 3221 to 322n, or may temporarily store metadata (for example, a mapping table) of the flash memories 3221 to 322n. The buffer memory 3240 may include a volatile memory such as a DRAM, an SDRAM, a DDR SDRAM, an LPDDR SDRAM, and a GRAM, or a non-volatile memory such as an FRAM, a ReRAM, an STT-MRAM, and a PRAM.

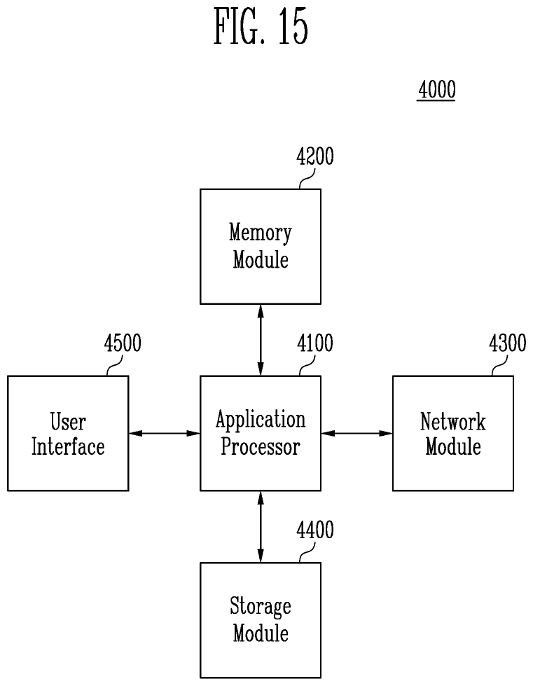

FIG. 15 is a block diagram illustrating a user system to which the storage device is applied according to an embodiment of the present disclosure.

Referring to FIG. 15, the user system 4000 includes an application processor 4100, a memory module 4200, a network module 4300, a storage module 4400, and a user interface 4500.

The application processor 4100 may drive components, an operating system (OS), a user program, or the like included in the user system 4000. For example, the application processor 4100 may include controllers, interfaces, graphics engines, and the like that control the components included in the user system 4000. The application processor 4100 may be provided as a system-on-chip (SoC).

The memory module 4200 may operate as a main memory, an operation memory, a buffer memory, or a cache memory of the user system 4000. The memory module 4200 may include a volatile random access memory such as a DRAM, an SDRAM, a DDR SDRAM, a DDR2 SDRAM, a DDR3 SDRAM, an LPDDR SDARM, an LPDDR2 SDRAM, and an LPDDR3 SDRAM, or a non-volatile random access memory, such as a PRAM, a ReRAM, an MRAM, and/or an FRAM. For example, the application processor 4100 and memory module 4200 may be packaged as a package on package (POP) and provided as one semiconductor package.

The network module 4300 may communicate with external devices. For example, the network module 4300 may support wireless communication such as code division multiple access (CDMA), global system for mobile communications (GSM), wideband CDMA (WCDMA), CDMA-2000, time division multiple access (TDMA), long term evolution, Wimax, WLAN, UWB, Bluetooth, and Wi-Fi. For example, the network module 4300 may be included in the application processor 4100.

The storage module 4400 may store data. For example, the storage module 4400 may store data received from the application processor 4100. Alternatively, the storage module 4400 may transmit data stored in the storage module 4400 to the application processor 4100. For example, the storage module 4400 may be implemented as a non-volatile semiconductor memory element such as a phase-change RAM (PRAM), a magnetic RAM (MRAM), a resistive RAM (RRAM), a NAND flash, a NOR flash, and/or a three-dimensional NAND flash. For example, the storage module 4400 may be provided as a removable storage device (removable drive), such as a memory card, and an external drive of the user system 4000.

For example, the storage module 4400 may include a plurality of non-volatile memory devices, each of which may operate the same as the memory device 100 described with reference to FIG. 1. The storage module 4400 may operate the same as the storage device 50 described with reference to FIG. 1.

The user interface 4500 may include interfaces for inputting data or an instruction to the application processor 4100 or for outputting data to an external device. For example, the user interface 4500 may include user input interfaces such as a keyboard, a keypad, a button, a touch panel, a touch screen, a touch pad, a touch ball, a camera, a microphone, a gyroscope sensor, a vibration sensor, and a piezoelectric element. The user interface 4500 may include user output interfaces such as a liquid crystal display (LCD), an organic light emitting diode (OLED) display device, an active matrix OLED (AMOLED) display device, an LED, a speaker, and a monitor.

While various embodiments of the present invention have been illustrated and described, various modifications and changes may be made to any of the disclosed embodiments, as those skilled in the art will understand in light of the present disclosure. Thus, the present invention encompasses all such changes and modifications that fall within the scope of the claims including their equivalents.

What is claimed is:

1. A storage device comprising:
a first memory controller configured to communicate with a host and control a first memory device group; and
a second memory controller configured to communicate with the first memory controller and control a second memory device group,
wherein the first memory controller controls the first memory device group based on a first address mapping method, and controls the second memory device group through the second memory controller based on a second address mapping method different from the first address mapping method.

2. The storage device of claim 1,
wherein the first memory controller stores a first mapping table corresponding to the first memory device group and a second mapping table corresponding to the second memory device group, and
wherein the first mapping table and the second mapping table are configured by on different mapping units.

3. The storage device of claim 2, wherein the first memory controller receives a write request, data, and a logical address from the host, and controls the first or second memory device group, which is selected based on the logical address, to perform a write operation.

4. The storage device of claim 3, wherein when the logical address is included in a first logical address range, the first memory controller provides the first memory device group with a write command according to the write request and stores, in the first mapping table, mapping data generated based on the logical address and a physical address of an area, in which the data is to be stored in the first memory device group.

5. The storage device of claim 4, wherein when the logical address is included in a second logical address range different from the first logical address range, the first memory controller provides the write command to the second memory controller and stores, in the second mapping table, mapping data generated based on the logical address and a physical address of an area, in which the data is to be stored in the second memory device group.

6. The storage device of claim 3, wherein when the logical address corresponds to random write data, the first memory controller provides the first memory device group with a write command according to the write request and stores, in the first mapping table, mapping data generated based on the logical address and a physical address of an area, in which the data is to be stored in the first memory device group.

7. The storage device of claim 6, wherein when the logical address corresponds to sequential write data, the first memory controller provides the write command to the second memory controller and stores, in the second mapping table, mapping data generated based on the logical address and a physical address of an area, in which the data is to be stored in the second memory device group.

8. The storage device of claim 2, wherein the first memory controller receives a read request and a logical address from the host, and controls the first or second memory device group, which is selected based on the logical address to perform a read operation.

9. The storage device of claim 8, wherein when the logical address is included in the first mapping table, the first memory controller provides a read command according to the read request and a physical address mapped with the logical address in the first mapping table to the first memory device group.

10. The storage device of claim 8, wherein when the logical address is included in the second mapping table, the first memory controller provides a read command according to the read request and a physical address mapped with the logical address in the second mapping table to the second memory controller.

11. The storage device of claim 2, wherein the first mapping table is configured by a mapping unit smaller than a mapping unit by which the second mapping table is configured.

12. The storage device of claim 1, wherein the first memory controller comprises:
a host interface configured to communicate with the host;
a memory interface configured to communicate with the first group of memory device;
a chip interface configured to communicate with the second memory controller;
a flash controller configured to control the first memory device group and control the second memory device group through the second memory controller; and
a memory buffer configured to store a mapping table corresponding to each of the first and second memory device groups, and
wherein the second memory controller comprises:
a chip interface configured to communicate with the first memory controller;
a memory interface configured to communicate with the second memory device group; and
a flash controller configured to control a second memory device group based on control of the first memory controller.

13. A memory controller that controls a first memory device group and controls a second memory device group through a sub controller, the memory controller comprising:
a map data manager configured to store a first mapping table corresponding to the first memory device group and a second mapping table corresponding to the second memory device group; and
an operation controller configured to generate a command according to a request received from a host and provide the command to the first memory device group or the sub memory controller based on a logical address provided from the host,
wherein the first mapping table and the second mapping table are configured by different mapping units.

14. The memory controller of claim 13, wherein when the request is a write request and the logical address is included in the first logical address range, the operation controller provides the first memory device group with the command, data provided from the host, and a physical address of an area, in which the data is to be stored in the first memory device group.

15. The memory controller of claim 14, wherein when the logical address is included in a second logical address range different from the first logical address range, the operation controller provides the sub controller with the command, the data, and a physical address of an area, in which the data is to be stored in the second memory device group.

16. The memory controller of claim 13, wherein when the request is a write request and the logical address corresponds to random write data, the operation controller provides the first memory device group with the command, data provided from the host, and a physical address of an area, in which the data is to be stored in the first memory device group.

17. The memory controller of claim 13, wherein when the request is a write request and the logical address corresponds to sequential write data, the operation controller provides the sub controller with the command, data received from the host, and a physical address of an area, in which the data is to be stored in the second memory device group.

18. The memory controller of claim 13, wherein when the request is a read request, the operation controller provides the command to the first memory device group or the sub controller according to whether the logical address is included in the first mapping table or the second mapping table.

19. The memory controller of claim 13, wherein the first mapping table is configured by a mapping unit smaller than a mapping unit by which the second mapping table is configured.

20. A storage device comprising:
one or more first memory devices each of which performs operations in units of pages;
one or more second memory devices each of which performs operations in units of zones;
a first controller configured to:
control one of the first memory devices to perform an operation according to a first physical address indicating a page within the first memory devices by translating a first logical address to the first physical address; and
generate a command with a second physical address indicating a zone within one of the second memory devices by translating a second logical address to the second physical address;
a second controller configured to control, in response to the command, the second memory device to perform an operation according to the second physical address,
wherein the zone is a greater unit than the page.
